(19) United States
(12) Patent Application Publication
(10) Pub. No.: US 2016/0342929 A1
(43) Pub. Date: Nov. 24, 2016

(54) METHOD FOR DETERMINING STAFFING NEEDS BASED IN PART ON SENSOR INPUTS

(71) Applicant: PERCOLATA CORPORATION, Palo Alto, CA (US)

(72) Inventors: Greg Tanaka, Palo Alto, CA (US); Zhixin Liu, Sunnyvale, CA (US); Garrett Wong, San Francisco, CA (US); Zhijuan Gao, Mountain View, CA (US); Ming Liu, Palo Alto, CA (US); Patrick Chung Ting Cho, Mountain View, CA (US); Shaun Kurien Benjamin, Mountain View, CA (US)

(21) Appl. No.: 15/161,012

(22) Filed: May 20, 2016

Related U.S. Application Data
(60) Provisional application No. 62/165,777, filed on May 22, 2015.
(60) Provisional application No. 62/265,334, filed on Dec. 9, 2015.

(51) Int. Cl. G06Q 10/06

(52) U.S. Cl. CPC G06Q 10/063116; G06Q 10/06314

(57) ABSTRACT

A system prepares a work schedule for a retail establishment. The system includes (a) a user interface for each of a plurality of employees to each specify time periods that the employee is available for work assignment; (b) a system of sensors installed in the retail establishment to detect customer traffic; and (c) a scheduler providing a preliminary work schedule that includes work assignments for the employees over a predetermined time period, based on the time periods specified by each employee and the customer traffic detected by the system of sensors. The systems's scheduling and employee management process predicts and recommends adequate staffing requirements based on customer traffic, purchasing data, and employee performance. The system also includes a tool for measuring and quantifying the impact of efficient scheduling on the retail store's revenue.

### CROSS REFERENCE TO RELATED APPLICATIONS

This application is a non-provisional application of and claims priority to (a) U.S. provisional patent application (“Provisional Application I”), entitled “Method for Determining Staffing Needs Based in Part on Sensor Inputs,” Ser. No. 62/165,777, filed on May 22, 2015, and (b) U.S. provisional patent application (“Provisional Application II”), entitled “System and Method for Optimizing Employee Scheduling in a Retail Store Environment According to Shopper Yield and Associate to Shopper Ratio,” Ser. No. 62/265,334, filed on Dec. 9, 2015. The disclosures of Provisional Application I and Provisional Application II are hereby incorporated by reference in their entireties.

### BACKGROUND OF THE INVENTION

1. Field of the Invention

The present invention relates to preparation of a work schedule based on a determination of staffing needs and the availability of employees to work during the time periods covered by the work schedule. The present invention also relates to techniques for data acquisition and analysis systems for business administration and management. In particular, the present invention determines the staffing needs in a commercial (e.g., retail) environment, based on inputs from sensors installed in the commercial environment and other variables. In that regard, the present invention applies systems and methods for forecasting and optimizing scheduling human resources using linear programming and other machine learning techniques.

2. Discussion of the Related Art

In a retail environment, greater customer traffic naturally implicates a greater need for personnel (e.g., sales associates) to be available to provide service. In this context, the retail environment refers not only to vendors of consumer goods or services, but also any establishment that receives customer foot traffic, such as restaurants, bars, or banks. However, personnel availability at any given time is the result of a scheduling process that depends on both employee availability and expected customer traffic. For the most part, many sales associates are part-time employees whose availabilities are constrained by the demands of other priorities, such as college classes or other employment. Also, because of a lack of a dynamic tool for an employee to update his/her availability frequently, an employee's proposed work schedule over time may no longer represent the employee's true availability.

A typical store manager responsible for creating a work schedule works manually with each employee's proposed availability and an anticipated pattern of customer traffic over the time periods covered by the work schedule. As one would expect, the manual process is time-consuming. Even when some automation of the process is available, the systems produce work schedules that require extensive manual adjustment or corrections due to other constraints (e.g., change in availability of an employee not timely reflected in the availability report). In addition, the anticipated customer traffic pattern is often based on outdated historical data, the store manager's “gut feelings” and other subjective, qualitative assessments. The historical data may be based, for example, on cash register receipts (“point-of-sale data”). In a low conversion rate environment (i.e., a low ratio of visitors coming into the store to the number of visitors who actually make a purchase), the point-of-sale data is a poor indicator of staff needs.

A mismatch between the resulting work schedule and the actual staffing needs may lead to higher labor cost (when overstaffed), or lower sales conversion and a lower service level (when understaffed).

Machine learning and data analytics are significant tools in business administration and management. Due to the difficulties in accurately predicting staff scheduling needs and the high cost of using management time to generate shift schedules, an automated solution to efficient allocation of human resources is needed.

### SUMMARY

According to one embodiment of the present invention, a system prepares a work schedule for a retail establishment. The system includes (a) a user interface for each of a plurality of employees to each specify time periods during which the employee is available for work assignment; (b) a system of sensors installed in the retail establishment to detect customer traffic; and (c) a scheduler providing a preliminary work schedule that includes work assignments for the employees over a predetermined time period, based on the time periods specified by each employee and the customer traffic detected by the system of sensors.

In one embodiment, the system of sensors includes sensors that detect electronic fingerprints of mobile electronic devices, such as the fingerprints of mobile electronic devices that communicate by WiFi (e.g., MAC addresses). The sensors may also include video cameras, access points for electronic communication, microphones and motion detectors. In one embodiment, a data fusion system receives and aggregates the data from the sensors. The data fusion system may reside remotely on a server “in the cloud”. Preferably, some sensors may be equipped to perform local data analysis before forwarding the data to the data fusion system over a wide area network. Local data analysis capability reduces the bandwidth requirement for forwarding sensor data.

In one embodiment, the system of sensors further detects occupancy in the retail establishment. The sensors may classify customers apart from the employees. The system of sensors may further classify the customers into other categories (e.g., by gender) based on sensor data, such as the electronic fingerprint.

In one embodiment, the system of sensors includes a prediction engine that predicts customer traffic at any given future time. The customer traffic prediction may take into consideration one or more of: data relating to weather, on-line web traffic, data received from a third-party, data relating to historical customer traffic, data relating to local events, and data relating to a marketing calendar.

In one embodiment, in preparing the preliminary work schedule, the scheduler may take into consideration one or more of the following input variables: store rules, data relating to compliance with government regulations, store events, financial data, and managerial preferences. The scheduler may be adaptive to the input variables. In one adaptation, the managerial preferences are modified based on a difference between the preliminary work schedule and a final work schedule resulting from editing by store management personnel. The scheduler may be implemented by a computer program that incorporates machine learning techniques.

In one embodiment, the user interface may be presented to an employee through an application program that runs on a mobile device.

In one embodiment, systems and methods are provided that collect and analyze customer, sales, and employee data obtained from a retail environment. In one embodiment, a method of the present invention effectuates both cost-savings and increased sales by ensuring efficient staff scheduling.

The present invention is better understood upon consideration of the detailed description below in conjunction with the accompanying drawings.

### BRIEF DESCRIPTION OF THE DRAWINGS

FIG. 1 is a functional block diagram of scheduling system 100, in accordance with one embodiment of the present invention.

FIG. 2 is a block diagram showing implementation 200 of scheduling system 100, in accordance with one embodiment of the present invention.

FIG. 3 is a functional block diagram showing implementation 300 of data fusion system 202, in accordance with one embodiment of the present invention.

FIG. 4 is a block diagram showing implementation 400 of scheduling program 206, in accordance with one embodiment of the present invention.

FIGS. 5(a) and 5(b) show, respectively, screens in app 101 displaying availability of an employee and the employee's personal calendar, according to one embodiment of the present invention.

FIG. 6 is a block diagram of a system and process for generating a feasible employee schedule.

FIGS. 7 (a) and 7(b), taken together, are a block diagram of a system and process for optimizing a feasible employee schedule based on employee performance.

FIG. 8 is a block diagram of a system and process for determining the impact of using optimal staff count and employee performance.

### DETAILED DESCRIPTION OF THE PREFERRED EMBODIMENTS

The present invention provides a tool for an employee to update his or her availability accurately and frequently, in order to reflect the employee's true availability. The present invention also provides an accurate model of customer traffic based in part on sensors placed throughout the retail establishment. The true employee availability and the accurate model of customer traffic allow the system to generate an optimized work schedule automatically. The optimized work schedule may be generated under a machine-learning approach so that the need for manual correction or adjustment is eliminated or reduced over time, as experience accrues. As a result, the present invention benefits the retail establishment by a higher sales conversion rate, leading to higher revenue and profits.

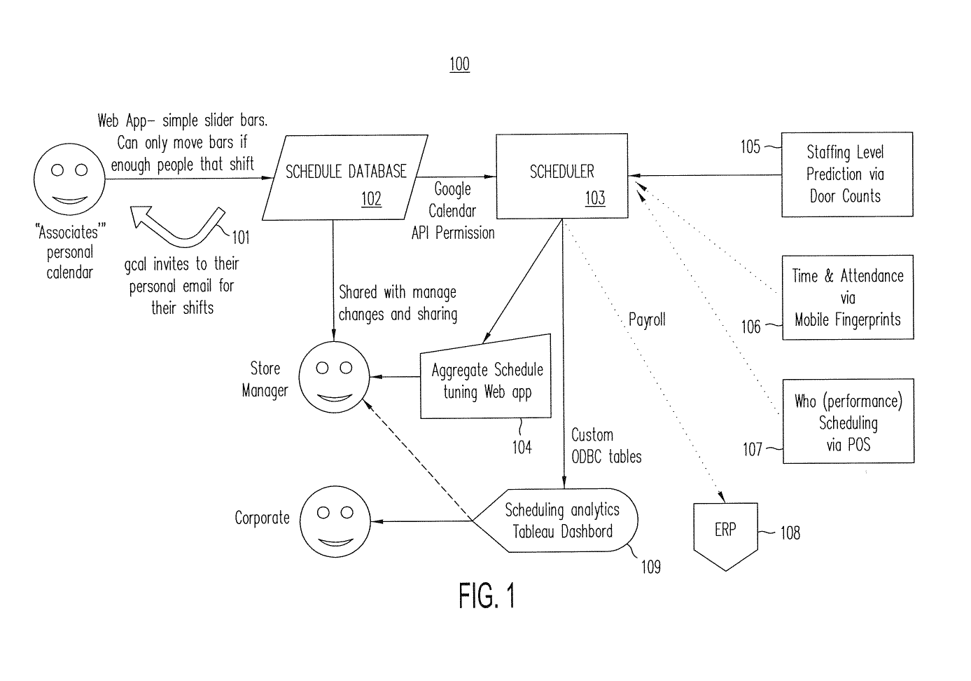

FIG. 1 is a functional block diagram of scheduling product 100, in accordance with one embodiment of the present invention. As shown in FIG. 1, application program (“app”) 101 interacts with each employee's personal calendar to maintain the employee's work schedule. In one embodiment, app 101 sends calendar invites (e.g., Google calendar invites) to each employee by email, which allows the employee to incorporate the work schedule into his or her personal calendar. App 101 also allows an employee to withdraw from a commitment on the calendar to work in a shift, when there are sufficient other workers to meet the staffing need for that shift. Schedule database 102 maintains all the work schedules and staffing for all the retail stores in the corporation. In one embodiment, schedule database 102 may be implemented by commercial spreadsheet software (e.g., Google Sheets). The employees may access their own schedules in schedule database 102 using app 101. Scheduler 103 may access schedule database 102 through an appropriate interface to extract employee availability, to examine existing work schedules, and to create and update work schedules in schedule database 102. App 104 allows a store manager to access the work schedules under his control and to make correction or adjustments, when necessary or desired.

To create or modify a work schedule, scheduler 103 receives staffing level requirements based from various sources or functional modules. For example, functional module 105 provides a staffing level prediction based on customer traffic data collected by various sensors installed in the retail store to be scheduled. Scheduler 103 may also receive from functional module 106 punctuality and attendance records of each employee, which may be used to ensure a level of reliability, and confidence or robustness in a schedule generated by scheduler 103. In one embodiment, punctuality, attendance and other personal performance data of each employee may be collected, provided that the employee is unambiguously identified by a “fingerprint”. In one embodiment, such a fingerprint may be provided by the employee's cellular telephone or any electronic device that respond to a query by returning a unique identifier. Functional module 106 may record the employee's showing up for work when an access point in the retail store registers the employee's cellular telephone. Likewise, functional module 106 may record the employee's departure from work when the employee's cellular telephone is no longer detected within the perimeter of retail store.

Scheduler 103 may further receive input from functional module 107, which provides data regarding the performance of each employee (e.g., sales conversion rates). Performance metrics can be, for example, an aggregate of one or more related metrics (e.g. shopper yield, conversion rate, call out rates, net promoter scores), each of which may be assigned a different weighting in the aggregate. For example, scheduler 103 may have a bias for scheduling the highest performing employees for work during the heaviest customer traffic. Functional module 107 may derive the performance of each employee from, for example, point-of-sale data.

Scheduler 103 may reside in a server accessible over a wide area network (i.e., “in the cloud”), such as the internet. Apps 101 and 104 may be downloaded and installed on smartphones.

Scheduler 103 may forward the punctuality and attendance records together with the work schedules to enterprise resource planning (ERP) module 108, which may use the data received for payroll processing. All the data received into scheduler 103 may be accumulated and aggregated by data analytic module 109 for mining data that may be useful to store managers and corporate managers. A store manager may also use app 104 to access data in scheduler 103 to allow the store manager to make personnel management decisions and to assist in optimizing work schedules. The store manager may also use app 104 to adjust the staffing levels, to provide performance data regarding specific employees, and to make notes or feedback of exceptional conditions. One example of an exceptional condition is when the expected customer traffic deviates substantially from the actual traffic. The feedback to scheduler 103 may be used to improve future scheduling decisions.

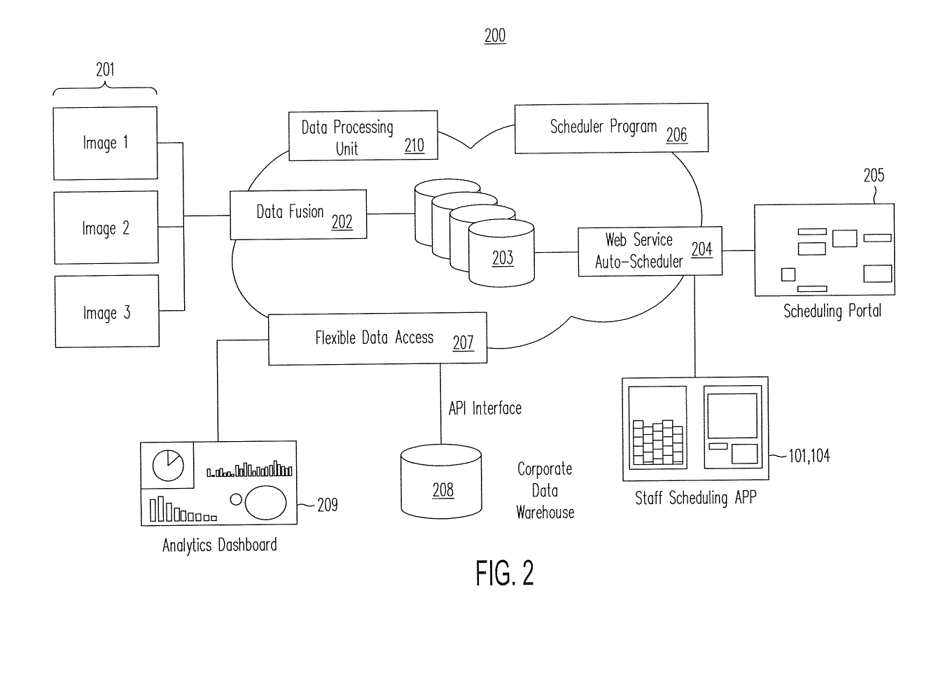

FIG. 2 is a block diagram showing implementation 200 of scheduling system 100, in accordance with one embodiment of the present invention. As shown in FIG. 2, a host of sensors 201 are installed in a retail store. Sensors 201 may include, for example, video cameras, access points for electronic communication, microphones and motion detectors. Sensors 201 may detect, for example, the entries and departures of customers, the movements between stations or the dwelling at stations by individual customers, the level of activities at various stations. One example of a customized sensor suitable for use in sensors 201 is disclosed in Copending patent application (“Copending Application”), Ser. No. 14/699,994, entitled “Methods, Systems, Apparatuses for Visitor Monitoring,” filed on Apr. 29, 2015. The disclosure Copending Application is hereby incorporated by reference in its entirety. Entries and exits of customer may also be detected by WiFi access points that can detect the presence and disappearance of smartphones.

Sensors 201 may provide its data to data fusion system 202, which may reside locally at the retail store, or alternatively reside remotely in the cloud. Preferably, the sensor data is directly provided to data fusion system 202 in the cloud. Preferably also, sensors 201 have some local data analysis capability. For example, some sensors may be able to classify an individual entering the store as “staff” based on the electronic fingerprints, or simply based on the recorded duration of stay (e.g., an employee may remain inside the retail store for hours, while it is unusual for a customer to stay a comparable duration). As another example, some sensors may provide the intensity or loudness of the sounds in the store, rather than simply providing an audio recording of the sounds. Alternatively, the sensor may provide the audio signal in the form of mel-frequency cepstrum coefficients (MFCCs). Sensors handling radio signals may also use triangulation techniques locally to determine if the signal comes from a device within the retail store or from a device just outside the store (e.g., at a display window). A local data analysis capability may reduce the bandwidth needed for transmitting data to data and fusion system 202.

In some implementation, processing sensor data may be carried out in data processing unit 210. For example, data analysis of video images may be carried out by data processing unit 210 using computer vision techniques. As another example, data analytic tasks and data-mining useful for corporate purposes may be carried out in data processing unit 210.

In some embodiments, free WiFi internet access may be provided to customers' mobile devices within the retail store. With the customer's acknowledged permission at sign-in, a web interface may retrieve from the mobile devices the customer's shopping-related information. For example, if a large number of customers have recently reviewed certain products offered in the retail store online, the staffing needs may include a preference for employees with specific knowledge of such products. Of course, such information may also allow the store to increase the inventory of such products, and to provide incentives to any customer who has shown interest in a particular product.

Sensor data from each retail store may be stored in database 203. Data fusion system 202 may implement the functional modules 106-108 of scheduling system 100. Web Service Auto-Scheduler 204 provides web interfaces to apps 101 and 104 used by the employees, as discussed above. The web interfaces may also include a scheduling portal 205 to allow authorized personnel to configure the scheduling parameters and administer scheduling system 100. Scheduler 103 may be implemented by scheduler program 206, which may be implemented as a self-optimizing application program using machine learning techniques.

Flexible data access system 207 allows users to access both the data in database 203 and corporate data warehouse 208. Analytic dashboard 209 provides access to data analytic resources in database 203 and corporate data warehouse 208 to allow data to be extracted or mined for analysis which may be useful for corporate decisions.

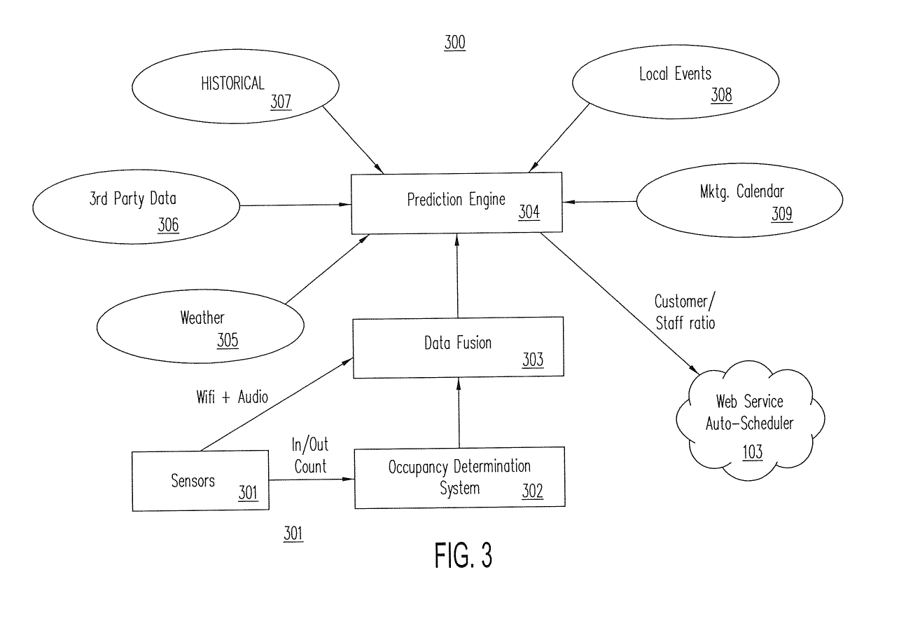

FIG. 3 is a functional block diagram showing implementation 300 of data fusion system 202, in accordance with one embodiment of the present invention. As shown in FIG. 3, sensors 301 installed at entries and exits of a retail store may be used to count the entries and exits of customers and staff into and out of the retail store. In this manner, at any given time, after excluding the staff, the number of actual and potential customers within the retail store may be determined in occupancy determination system 302. The level of audible noise and voices may also be used to confirm actual occupancy. Sensors 301 may also include sensors for detecting WiFi-enabled device and microphones for detecting audible sounds in specific areas or stations within the retail stores. These sensors provide additional data from which customer traffic and activities may be derived.

Data fusion system 202 takes the walking count from video, from mobile footprint derived from WiFi signals, from audio sequences, and from other data sources such as sales records, to generate a more accurate synthetic walking count, based on the assumption that the errors of walking counts from different data sources are independent from each other and hence can be canceled out by deliberately designed fusion algorithm. The fusion algorithm adopting neural network is proved to be effective for people counting synthesis.

The people walking count derived from video/mobile footprint/audio sequences/sales records indicate the traffic of customers of a retail store. The walking count can be interpreted in an approach called occupancy time. Occupancy time is the total amount of time people spend in an area for a certain period of time. This is a more accurate reflection of the workload for the sales people for that area. The occupancy time takes into account the entry and departing time of every person who walks in and out of the store. Based on the entry and departure timestamps, the average occupancy inside the store during any specified time period can be calculated and adopted as an indication of the traffic inside the store. The occupancy time from different data sources such as video/mobile fingerprint/audio/sales records can be synthesized by the same data fusion algorithm as described above to obtain a more accurate occupancy time.

Data fusion module 303 aggregates and analyzes the raw sensor data to determine the customer traffic and the customers' preferred areas or stations within the retail store. This information is fed into prediction engine 304 which also receives data relating to weather (305), data provided by third parties (306; e.g., current product promotions by manufacturers), data related to historical store traffic (307), data related to local events (308; e.g., street fairs) and marketing calendar (309; e.g., store promotion events). In predicting customer traffic at the retail store, prediction engine 304 may also take into consideration information relating customer interest at the current time for items available at the retail store. In this regard, online web traffic is useful as an indicator for ascertaining customer interest in goods and services rendered at the retail store. Some aspects of online web traffic data, such as data related to access to the “store locator” page (i.e., the page on which a retailer lists its stores), are indicative of whether or not and when a customer may visit a store. Such data may be further enhanced by examining the type of browsing device used and the geolocation information of that device, if available. For instance, when a shopper browses the store locator page using a smartphone that is located two blocks away from a retail store, that shopper is much more likely to visit that store than someone browsing from a desktop computer fifty miles away from the retail store. Based on these input data, prediction engine 304 may determine a staffing need forecast for a particular future date and time (e.g., for any time in the immediate future two-week window, at 15-minute resolutions). This staffing need forecast is provided to scheduler 103 for its determination of a preliminary work schedule.

In one embodiment, based on “fingerprints” from, for example, cellular telephones, prediction engine 304 may classify a specific customer to be a repeat visitor or a first-time visitor. Metrics relating to the needs of the two kinds of visitors (e.g., a first-time visitor may dwell longer at stations, or require additional help) may be taken into account in the staffing need forecast. The preferences of customers at certain stations may also suggest staffing of employees with specific expertise relevant to those stations. Other classifications based on sensor input are possible. For example, it is well-known that male shoppers and female shoppers exhibit different shopping behaviors. Sensors that can classify the occupants at the retail store according to gender may provide data that improve the determination of staffing needs. In addition, the fingerprint of a mobile device can be joined to other online fingerprints (e.g. browser cookie, advertising ID). By joining the mobile device fingerprint with other online fingerprints, a full path to purchase, which includes typically both online and offline paths, can be determined. This joining of fingerprints may happen when a shopper connects his or her smartphone via Wi-Fi to an access point. After the access point obtained the user's permission to connect, the access point may join both types of fingerprints and then forward the resulting information to a server in the cloud. Once these fingerprints are joined, retailers can then retarget the advertising that is sent to the shopper. For instance, if the shopper is in a store looking at a snowboard, the retailer can then target the shopper online with a snowboard advertisement, as the fingerprints are joined. Also by joining the fingerprints, the retailer can better ascertain the shopper's intent, as the retailer may already have information regarding what the shopper was looking online.

The detailed sensor data gathered store helps characterize shopper traffic and thus enable the retailer to better match its sales people to the expected shopper traffic. For example, if the characterized shopper traffic indicates that greater traffic by shoppers who are interested in snowboards than by shoppers interested in skis during a certain future period of time, the system can staff salespeople who have greater experience (e.g., as indicated by the POS system) selling snowboards during that time. By matching the salespeople to the type of shopper traffic coming into the store, the retailer can achieve greater conversion (i.e., more effectively sell the indicated goods). An expected conversion rate can be determined passively by examining statistical correlations from historical data or by proactively running simulations to determine the attributes of the store's existing sales people are best matched to the expected or indicated shopper traffic forecasted to realized the greatest sales. In addition, such of analysis may be used to determine the staff composition by examining factors determining team dynamics (e.g. not scheduling two top salespersons to work the same shift together, so as to avoid such salespersons from competing against each other for the same sale). Other team dynamics metrics my include individual sales associate metrics (e.g. tenure, age, total selling history). Shopper yield is a good metric for evaluating how well-matched the sales team is to the expected shopper traffic. Shopper yield can be determined from the data by a machine learning model.

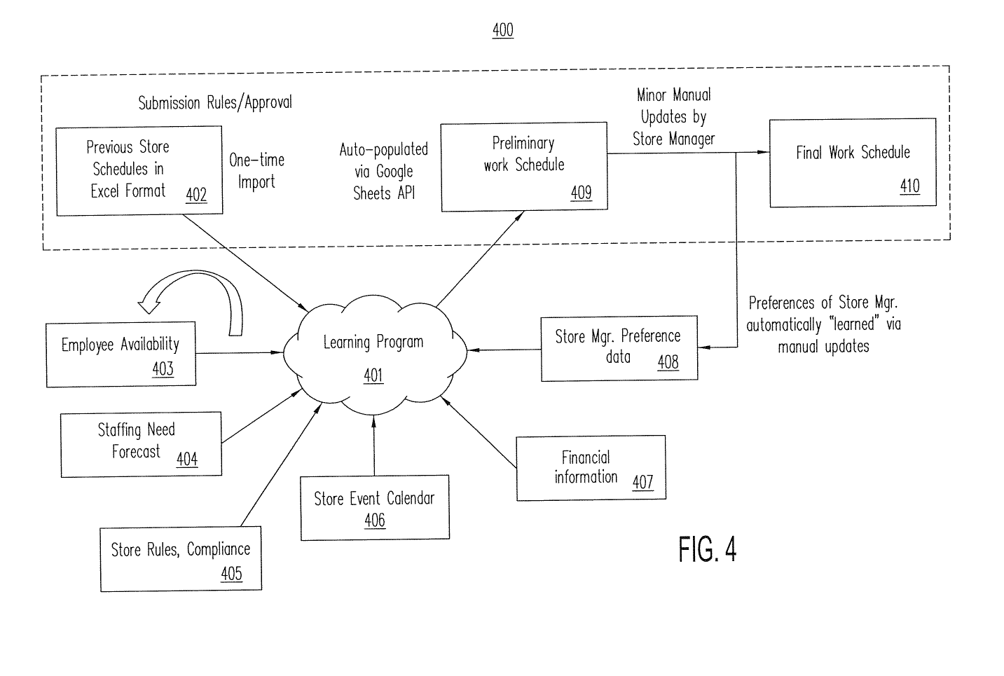

FIG. 4 is a block diagram showing implementation 400 of scheduling program 206, in accordance with one embodiment of the present invention. As shown in FIG. 4, for each retail store, a learning program 401 receives previous store schedules (402), employee availability data (403), staffing need forecast (404; from prediction engine 304), store rules and compliance data (405; e.g., store rules may require that certain specifically trained employees be present during store opening and store closing times), store event calendar (406), financial information (407; e.g., amount of sales during specific times), and store manager preference data (408). From these input data, learning program 401 generates a preliminary work schedule (409), which may be edited, adjusted or overridden by a store manager to arrive at a final work schedule (410). The preliminary work schedule may be result of a constrained maximization using data from the input data. For example, based on store rules and compliance data 405, scheduling program 206 provides a preliminary work schedule with employee assignments that take into consideration the cost of over-time wages and the need for coverage during employee rest periods or breaks.

The difference between preliminary work schedule 409 and final schedule 410 may be fed back to learning program 401 by updating store manager preference data 408. In addition, as part of generating preliminary work schedule 409, learning program 401 may approve or confirm each employee's proposed work schedule, or request additional availabilities from specific employees for slots that remain to be filled in the preliminary schedule. In this regard, based on the expected store traffic, conversion rates and other demands on store personnel (“personnel demand”) and the employee availability (“personnel supply”) for a given time slot, learning program 401 may dynamically determine an incentive bonus or an enhanced labor rate or wage to offer employees, so to induce employees to fill the slot outside of their committed availabilities. This market-based approach, i.e., based on matching personnel demand to personnel supply, aims to achieve optimal staffing for each time slot.

Learning program 401 may perfect its model of any variable based on feedback of the actual customer traffic realized. For example, as the actual traffic becomes historical store traffic data (307) over time, the weight or weights given to historical store traffic data 307 may be refined adaptively. Adaptation of the contribution of any input data may be achieved using any combination of machine learning techniques, such as running regressions, using Kalman filtering, gradient-based optimization, or neural network techniques.

In one embodiment, previous store schedules may be provided in spreadsheets (e.g., Google Sheets or Microsoft Excel). In one embodiment, preliminary work schedule 409 may also be provided as spreadsheets (e.g., Google Sheets) to allow easy edits by store managers.

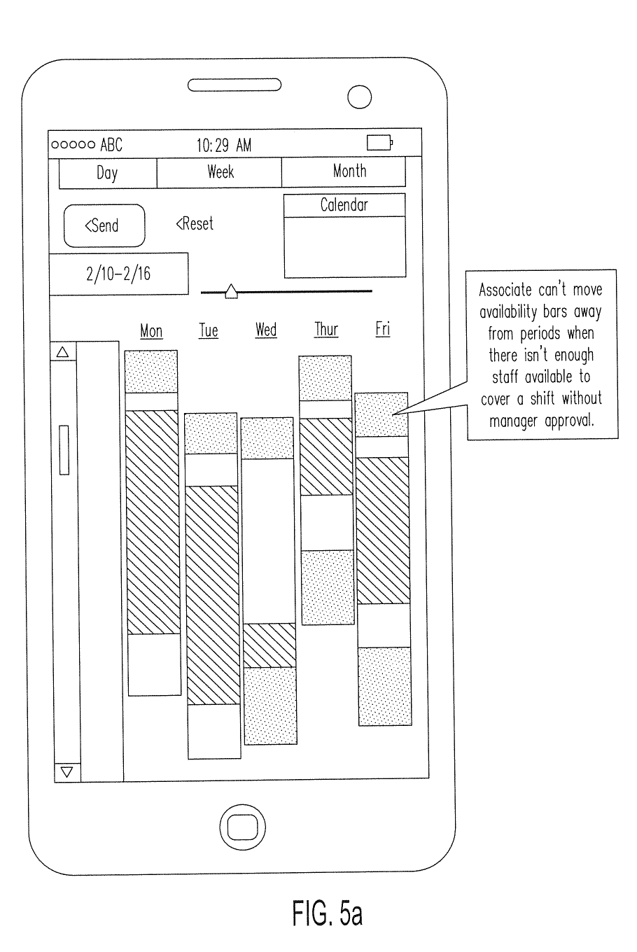

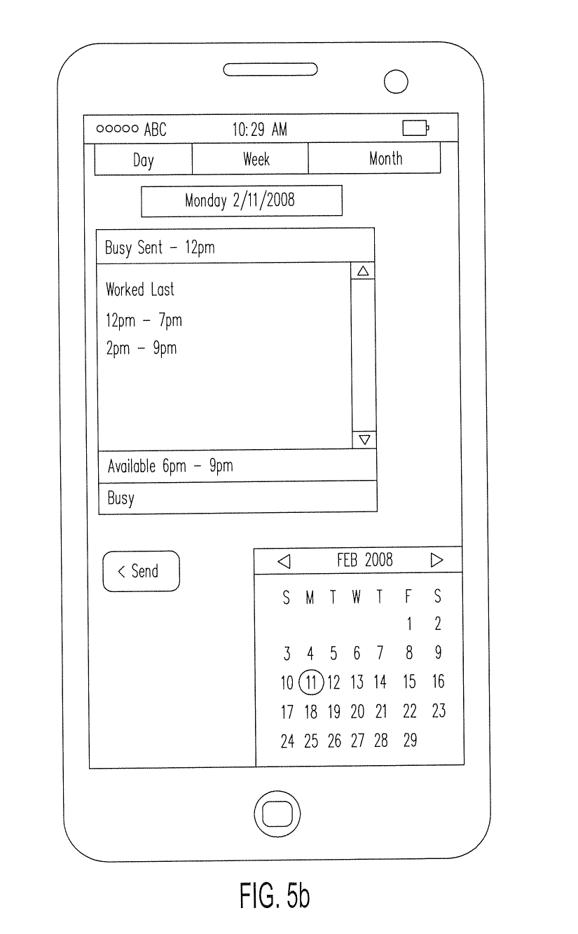

FIGS. 5(a) and 5(b) show, respectively, screens in app 101 displaying availability of an employee and the employee's personal calendar, according to one embodiment of the present invention. As shown in FIG. 5(a), the employee may not withdraw availability, unless the corresponding time slot is already otherwise staffed, or unless the store manager approves. App 101 may also allow the employee to specify his or her committed work schedules in one or more retail stores, and to specify additional times that the employee is willing to work, if required. App 101 may also allow shift swapping among employees themselves, upon proper authorization. In addition, if the system indicates that the store may be understaffed for a particular shift, the system may automatically send out an open shift request to the employees' telephones to seek employees availability for that shift. Likewise, when an employee requests time-off or a reduction in availability, the system can make recommendations to the manager based on expected shopper traffic and current staff availability to help the manager determine whether or not he or she should approve the time-off or the availablility reduction request.

The following description provides further specific exemplary embodiments of the present invention.

### Method of Generating a Feasible Employee Schedule Using Optimal Staff Count

In retail stores, a system and process for measuring and analyzing customers, sales, and employee data generates a feasible employee schedule which reduces operating costs by reducing instances of overstaffing and increases sales by reducing instances of understaffing.

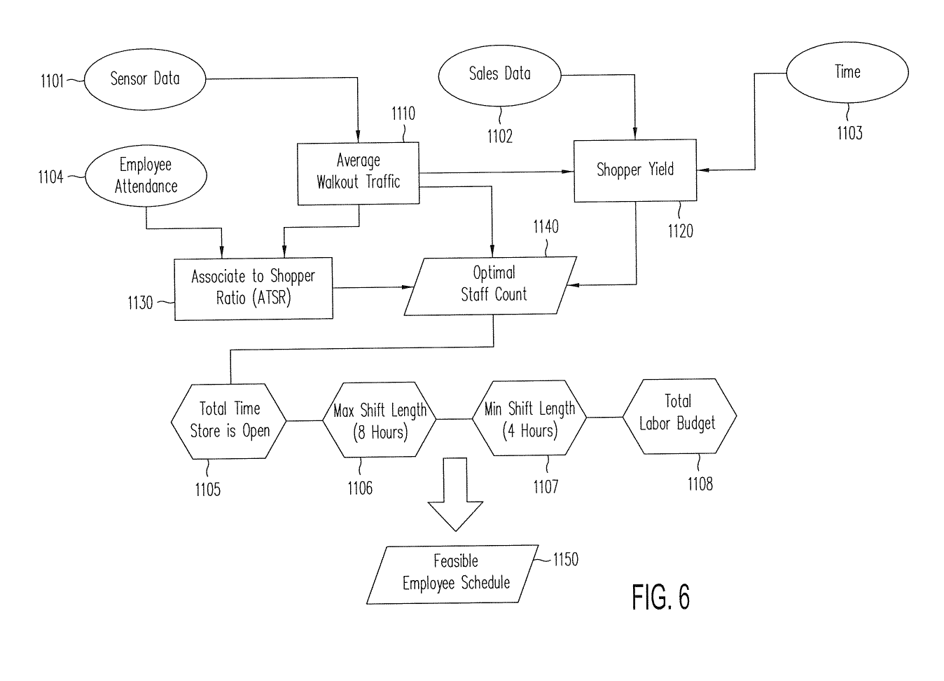

FIG. 6 shows a process for generating feasible employee schedule 1150 from optimal staff count 1140 and labor constraints, including total time 1105 the store is open, maximum shift length 1106 (e.g., 8 hours), minimum shift length 1107 (e.g., 4 hours), and the store's total labor budget 1108. Optimal staff count 1140 represents the number of employees needed to maximize sales at any given time of day based on a modeled relationship between associate-to-shopper ratio (ATSR) 1130 and shopper yield 1120. Shopper yield 1120 is a ratio of sales to shoppers and is calculated according to average walkout traffic 1110, sales data 1102, and time of day 1103. ATSR 1130 is a ratio of store associates to shoppers inside the store and is calculated from employee attendance records 1104 and average walkout traffic 1110. Both ATSR 1130 and shopper yield 1120 depend on the number of customers in the store, which is estimated using average walkout traffic 1110. Average walkout traffic 1110 is a measure of the number of customers leaving the store, which is calculated from sensor data 1101 and which includes both the number of customers leaving the store and the time of day each customer left the store.

Optimal staff count 1140 is predicted by modeling a relationship between ATSR 1130 and shopper yield 1120 in a way that maximizes shopper yield 1120. Once an optimal associate-to-shopper ratio is determined from the modeled relationship, optimal staff count 1140 may be determined for each hour the store operates by multiplying optimal ATSR 1130 at that hour to the corresponding average walkout traffic 1110 at that hour. A feasible employee schedule 1150 is generated by modeling employee staffing as an objective function that includes constraints such as, but are not limited to, total time 1105 during which the store is open, maximum employee shift length 1106, minimum employee shift length 1107 and total labor budget 1108 of the retail operation.

### Method of Optimizing a Feasible Employee Schedule Based on Employee Performance

In a retail environment, scheduling employees for work according to employee performance can increase sales. Specifically, by scheduling the highest performing employees to work during shifts with the greatest expected sales, the greatest opportunity to increase sales may be realized. Accordingly, one embodiment of the invention described herein provides a system and process that modify feasible employee schedule 1150 (e.g., the feasible employee schedule generated from the process described in FIG. 6) based on employee performance to provide a ranked feasible employee schedule, which enhances the revenue potential of a retail environment, while decreasing operating costs by ensuring efficient scheduling.

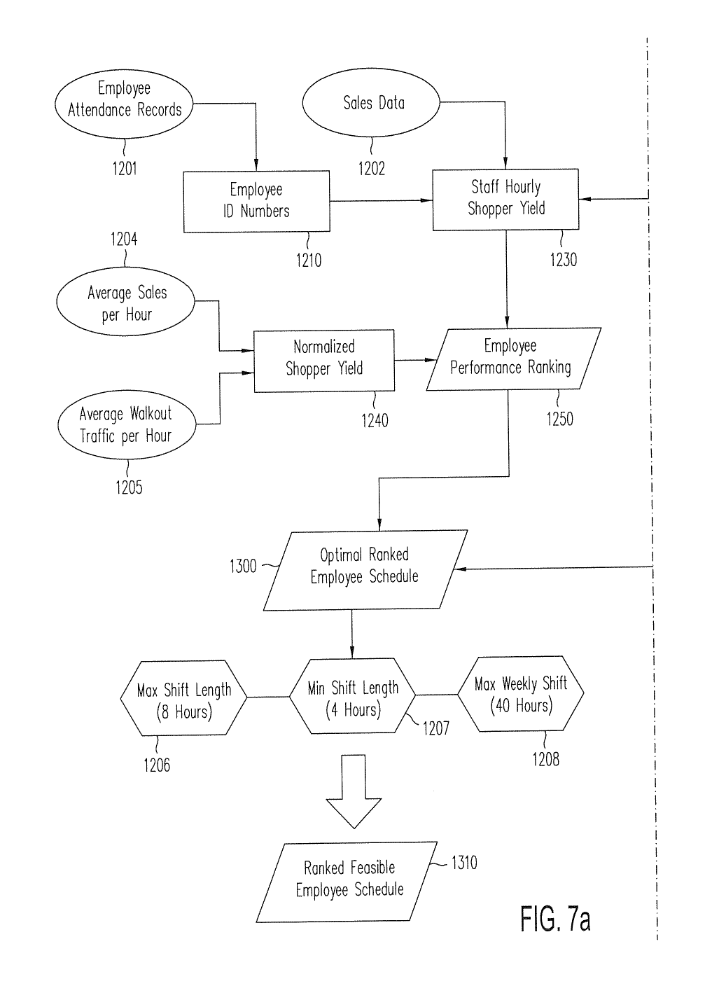

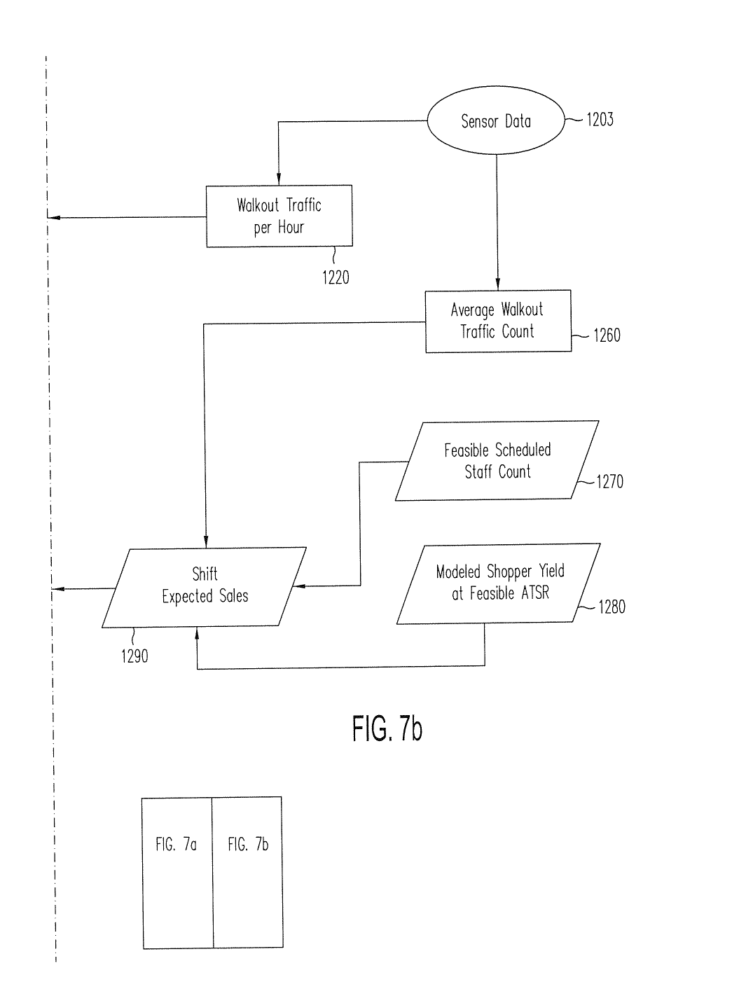

FIGS. 7 (a) and 7(b), taken together, are a block diagram showing a system and process that generate ranked feasible employee schedule 1310 based on employee performance ranking 1250 and shift expected sales 1290. Employee performance ranking 1250 determines a performance score for each employee relative to a baseline level of performance. The performance score for each employee may be obtained by calculating a difference between actual staff hourly shopper yield 1230 attributable to the employee and corresponding normalized shopper yield 1240 attributable to that employee. To compile employee performance ranking 1250, unique employee ID numbers 1210 are assigned to the employees according to their punch-in and punch-out times stored as employee attendance records 1201. The performance of each employee corresponds to staff hourly shopper yield 1230. Staff hourly shopper yield 1230 is a ratio of sales to shoppers and is calculated for every hour the store is open using sales data 1202, and walkout traffic per hour 1220. Sales data 1202 includes the number of customers leaving the store and their times of departure. Walkout traffic per hour 1220 reflects the number of customers leaving the store every hour and is calculated from sensor data 1203 generated by a sensing device that tracks customers leaving the store. One example of such a sensor includes an “eyestalk” device provided by Percolata Corporation, Santa Clara, Calif., which comprises at least one “eyestalk” sensor for customer tracking and a mobile chipset for relaying by wireless communication the collected data to one or more servers.

To determine employee performance ranking 1250 for every employee, total staff hourly shopper yield 1230 is divided equally among all employees working during a measured period of staff shopper yield. Equal attribution of staff hourly shopper yield 1230 is accomplished by dividing the total staff shopper yield generated during a measured period by the number of employees working during that measured period and associating an apportioned hourly shopper yield value with each working employee ID number 1210. An employee's total attributed hourly shopper yield is then calculated by aggregating the apportioned shopper yield value for each hour the employee worked and dividing the result by the total number of hours worked. The employee's total attributed hourly shopper yield 1230 is then compared to normalized shopper yield 1240 to assess performance. Employees with higher values in staff hourly shopper yield 1230 have higher rankings in employee performance ranking 1250 than employees with lower values in hourly shopper yield 1230.

Normalized shopper yield 1240 equalizes shopper yield based on a historic baseline sales and customer traffic values by reducing discrepancies in shopper yield data caused by random variation and seasonal differences. Normalized shopper yield 1240 is calculated by dividing average sales per hour 1204 by average walkout traffic per hour 1205. Normalized shopper yield 1240 may have a value that is different for each employee because it depends on both the number of hours worked and the times of day the employee was on duty. For example, employees working only twenty hours a week are compared against a normalized shopper yield 1240 value that represents twenty hours of work, while employees working forty hours a week are compared against a value for normalized shopper yield 1240 that represents forty hours of work. Similarly, an employee working only low traffic hours is compared to a value of normalized shopper yield 1240 that corresponds to those same low traffic hours, while, an employee working only during high traffic hours is compared to a value of normalized shopper yield 1240 that corresponds to those same high traffic hours.

Shift expected sales 1290 measures the total predicted sales a shift generates with an optimized number of employees in the shift. Shift expected sales 1290 is obtained by generating feasible scheduled staff count 1270 from a relationship between shopper yield and an associate-to-shopper ratio (ATSR) modeled in a way which maximizes shopper yield and constrains staff count, according to operation-specific constraints on employee shift length and labor budget. Modeling ATSR and shopper yield in this way produces a modeled shopper yield at feasible ATSR 1280. The modeled shopper yield at feasible ATSR 1280 is then multiplied by average walkout traffic count 1260 to generate shift expected sales 1290. Average traffic count 1260 is obtained from sensor data 1203, which is provided an in-store customer tracking sensor. Actual sales data can also be used for this purpose. For example, instead of relying on predicted sales based on a modeled shopper yield at feasible ATSR 1280 to calculate shift sales, actual sales data obtained during a shift can be used. Using actual sales—instead of predicted sales—works well once a store has optimized its staff count according to the ATSR which maximizes shopper yield and has measured the sales generated during each optimized shift for a substantial time period to minimize random variation and seasonal differences.

Optimal ranked employee schedule 1300 maximizes sales by assigning employees to shifts based on their individual performance rankings and the expected sales for each shift. Shift expected sales 1290 predicts the number of sales each shift generates with the optimal number of employees working in each shift. As discussed above, employee performance ranking 1250 ranks each individual employee's performance. Shift expected sales 1290 and employee performance rankling together provide optimal ranked employee schedule 1300, which places the highest ranking employees on shifts that generate the most sales. Optimal ranked employee schedule 1300 is then constrained by maximum shift length 1206, minimum shift length 1207, and the maximum weekly shift 1208 to generate ranked feasible employee schedule 1310. Ranked feasible employee schedule 1310 maximizes store sales by assigning the highest performing employees to shifts which generate the most expected sales within the employee shift constraints prescribed by the store. Ranked feasible employee schedule 1310 incorporates and further builds upon the feasible employee schedule generated by the system and process described in FIG. 6, using employee performance ranking 1250 and shift expected sales 1290.

By combining the feasible employee scheduling system of FIG. 6 with the ranked feasible employee scheduling system of FIGS. 7(a) and 7(b), the invention described herein provides a tool for locating instances of over-staffing and understaffing and results in increased sales, as employees with the highest rankings under employee performance ranking 1250 are assigned to shifts with the most expected sales. A system of performance-based scheduling assures a store's most capable employees are on duty to assist customers who are most likely to produce sales. Similarly, store managers can also be scheduled according to performance based on the system and process described for employees in FIGS. 7(a) and 7(b). In the case of store managers, managers with the highest performance rankings are scheduled to work during shifts with the greatest number of expected sales or the greatest customer traffic. This method of scheduling allows for the highest performing managers to be on duty to manage the store during periods when customers are most likely to purchase items. Instances of high shopper yield and high customer traffic have proven to be indicative of such high-purchase probability periods.

Alternatively, the system may allow a preference or greater freedom to the high-performing employees to select their shifts, as a reward for their performance. Such a non-monetary incentive tends to increase individual performance by all employees, as greater freedom in selecting one's own shift is generally desired by all employees. Employees of lesser performance can select their hours after selection by the higher performing employees, or with lower priority than that of employees of higher performance. As mentioned above, the hours that are available to work at a store are determined by the expected shopper traffic data for the store.

### Method of Determining the Impact of Scheduling Using Optimal Staff Count and Employee Performance

A new system for scheduling employees in a retail environment requires an initial investment that may realize gains in the long run. Moreover, it is often difficult to realize the impact of data analytics in some tangible form. Assessing the added value of an optimized scheduling system relative to a traditional scheduling system (i.e., the opportunity cost of a new system) is therefore important to inform a store owner's decision to invest in the new system. One embodiment of the invention described herein determines an opportunity cost or impact of scheduling using optimal staff count and employee performance.

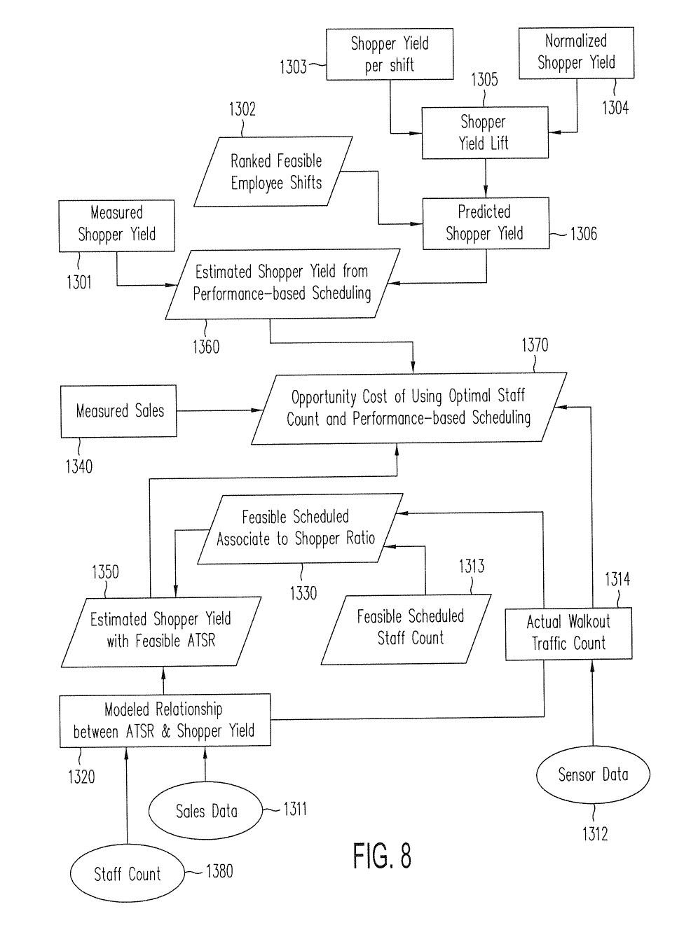

FIG. 8 is a block diagram illustrating a system and process for determining opportunity cost of using optimal staff count and performance-based scheduling 1370. Opportunity cost of using optimal staff count and performance-based scheduling 1370 represents an increase in sales resulting from scheduling employees according to both employee performance and an optimal staff count, as calculated using estimated shopper yield applying shift lift 1360, measured sales 1340, and estimated shopper yield with feasible ATSR 1350.

Estimated shopper yield from performance-based scheduling 1360 is the predicted shopper yield resulting from optimizing scheduling according to employee performance. Estimated shopper yield from performance-based scheduling 1360 is provided by a difference between measured shopper yield 1301 and predicted shopper yield 1306. Predicted shopper yield 1306 is calculated by determining shopper yield lift 1305 for all ranked feasible employee shifts 1302. Shopper yield lift 1305 is determined by predicting an increase in shopper yield provided by scheduling an optimal number of employees according to performance. Shopper yield lift 1305 is measured as a difference between shopper yield per shift 1303 and normalized shopper yield 1304. Shopper yield per shift 1303 aggregates the values of the shopper yields attributable to the employees working during the shift. Normalized shopper yield 1304 is an average shopper yield expected at a particular day and time based on historical average sales and the average walkout traffic. The difference between predicted shopper yield per shift 1303 and normalized shopper yield 1304 provides shopper yield lift 1305. Predicted shopper yield 1306 is then determined by calculating the shopper yield lifts for all ranked feasible employee shifts 1302. The difference between predicted shopper yield 1305 and measured shopper yield 1301 is then given as estimated shopper yield from performance-based scheduling 1360.

Estimated shopper yield with feasible ATSR 1350 measures the predicted shopper yield using an optimal staff count. Estimated shopper yield with feasible ATSR 1350 depends on modeled relationship between ATSR and shopper yield 1320 and feasible scheduled associate-to-shopper ratio 1330. Modeled relationship between ATSR and shopper yield 1320 is calculated by relating staff count 1380 to sales data 1311 in a way that maximizes shopper yield. Actual walkout traffic count 1314 (obtained from sensor data 1312) is then multiplied by the ATSR required to maximize shopper yield to determine the value of modeled relationship between ATSR and shopper yield 1320. Feasible scheduled associate-to-shopper ratio 1330 reflects an optimal number of employees needed to serve the number of customers within the store-specific employee shift and labor constraints. Feasible scheduled associate-to-shopper ratio 1330 is determined by dividing actual walkout traffic count 1314 by feasible scheduled staff count 1313. Actual walkout traffic count 1314 is determined from sensor data 1312 generated by a sensor designed to track store customers. Feasible scheduled staff count 1313 is generated according to the ATSR needed to maximize shopper yield within the labor cost and employee shift constraints defined by the store. Average walkout traffic count 1314 is divided by feasible scheduled staff count 1313 to produce feasible scheduled associate-to-shopper ratio 1330. Feasible scheduled associate-to-shopper ratio 1330 is combined with modeled relationship between ATSR and shopper yield 1320—produced from staff count 1380, sales data 1311, and actual walkout traffic count 1314—to determine estimated shopper yield with feasible ATSR 1350. For example, if the value of feasible scheduled associate-to-shopper ratio 1330 is one and the value of modeled relationship between ATSR and shopper yield 1320 is one-to-two, the value of estimated shopper yield with feasible ATSR 1350 is two.

Estimated shopper yield with feasible ATSR 1350 is then combined with estimated shopper yield from performance-based scheduling 1360 to obtain a total expected shopper yield. This total expected shopper yield results from by a scheduling system which optimizes staff count and schedules employee shifts according to employee performance. The total expected shopper yield is then multiplied by actual walkout traffic count 1314 to determine a total predicted total sales revenue. This predicted total sales revenue is then compared with actual measured sales 1304 to provide opportunity cost of using optimal staff count and performance based scheduling 1370.

The above detailed description is provided to illustrate specific embodiments of the present invention and is not intended to be limiting. Numerous variations and modifications within the scope of the present invention are possible. The present invention is set forth in the accompanying claims.

We claim:

1. A system for preparing a work schedule for a retail establishment, comprising:
a user interface for each of a plurality of employees to each specify time periods that the employee is available for work assignment;
a system of sensors installed in the retail establishment to detect customer traffic; and
a scheduler providing a preliminary work schedule that includes work assignments for the employees over a predetermined time period, based on the time periods specified by each employee and the customer traffic detected by the system of sensors.

2. The system of claim 1, wherein the system of sensors includes sensors that detect electronic fingerprints of a mobile electronic device.

3. The system of claim 2, wherein the mobile electronic device communicates by WiFi.

4. The system of claim 1, wherein the system of sensors comprise two or more sensors selected from the group consisting of video cameras, access points for electronic communication, microphones and motion detectors.

5. The system of claim 4, further comprising a data fusion system that receives and aggregates the data from the sensors.

6. The system of claim 5, wherein the data fusion system resides on a server at a remote location.

7. The system of claim 6, wherein the sensors perform local data analysis before forwarding the data to the data fusion system over a wide area network.

8. The system of claim 4, wherein the system of sensors further detect occupancy in the retail establishment.

9. The system of claim 8, wherein the system uses the detected occupancy time to determine customer traffic.

10. The system of claim 4, wherein the system of sensors identifies and distinguishes between customers from employees.

11. The system of claim 8, wherein the system of sensors further classifies the customers into categories based on sensor data.

12. The system of claim 4, wherein the system of sensors includes a prediction engine that predicts customer traffic at any given future time.

13. The system of claim 12, wherein the prediction engine takes into consideration one or more of: data relating to weather, on-line web traffic, data received from a third-party, data relating to historical customer traffic, data relating to local events, and data relating to a marketing calendar.

14. The system of claim 1, wherein the scheduler takes into consideration one or more of the following input variables: store rules, data relating to compliance with government regulations, store events, financial data, and managerial preferences.

15. The system of claim 14, wherein the scheduler is adaptive to the input variables.

16. The system of claim 15, wherein the scheduler adaptively modifies the managerial preferences based on a difference between the preliminary work schedule and a final work schedule resulting from editing by store management personnel.

17. The system of claim 1, wherein the scheduler comprises a computer program that incorporates machine learning techniques.

18. The system of claim 1, wherein the user interface is presented to an employee through an application program that runs on a mobile device.

19. The system of claim 1, wherein the scheduler may request additional availabilities from employees to fill slots in the preliminary schedule.

20. The system of claim 19 wherein, in conjunction with the request for additional availabilities, an incentive bonus or an enhanced labor rate or wage is offered to the employees.

21. The system of claim 20, wherein the incentive bonus or enhanced labor rate or wage is computed by the scheduler based on a model for matching personnel demand to personnel supply.

22. A process of scheduling a plurality of employees in a retail store, said scheduling process comprising:
predicting a staff count, being a number of employees needed to maximize sales, by relating customer traffic data, sales data, and employee attendance data;
generating shifts with said staff count for every hour in a time period during which the store is open, so that each shift contains a number of employees equal to said staff count;
modifying said shifts to produce feasible shifts by conforming said shifts to fit within a set of labor and employee constraints; and
compiling said feasible shifts to generate a feasible employee schedule, wherein the feasible employee schedule covers the time period completely.

23. The process of claim 22 wherein said customer traffic data includes numbers of customers walking out of the store in detected at regular intervals by an optical sensor or a visual monitoring device.

24. The process of claim 23, wherein the visual monitoring device comprises a mobile chipset with at least one eyestalk sensor coupled to the mobile chipset.

25. The process of claim 24, wherein the mobile chipset supports wireless communication.

26. The process of claim 22, wherein said sales data comprises a list of time-stamped sale transactions and wherein said employee attendance data comprises a list of punch-in and punch-out times for each employee.

27. The process of claim 22, wherein said step of predicting a staff count is achieved by modeling a relationship between a shopper yield and an associate-to-shopper ratio (ATSR) in a way which achieves the highest value for said shopper yield.

28. The process of claim 27, further comprising calculating said shopper-yield by dividing an amount of sales generated over a defined time period by a number of customers leaving the store over the defined time period.

29. The process of claim 28, further comprising calculating the ATSR by dividing the number of employees assigned to work during a defined period by the number of customers leaving the store over the defined period.

30. The process of claim 22 wherein the set of labor and employee constraints comprises:
a total time during which the store is open;
a maximum shift length;
a minimum shift length:
a maximum weekly shift length; and
a total labor budget.

31. The process of claim 22, wherein generating shifts takes into account said ATSR for each shift.

32. The process of claim 31, further comprising:
predicting an estimated shopper yield for each of said feasible shifts;
aggregating said estimated shopper yields for each feasible shift during said defined period; and
determining an opportunity cost of using said feasible employee schedule by comparing total value of said estimated shopper yields to total value of sales recorded during said defined period.

33. A process of scheduling a plurality of employees in a retail store, comprising:
predicting a staff count needed to maximize sales at the retail store by relating customer traffic data, sales data, and employee attendance data;
ranking the employees according to employee performance data;
generating shifts with said staff count for every hour for a time period during which the retail store is open;
modifying said shifts to provide ranked employee shifts by matching the employees with higher ranks to shifts with higher sales based on said sales data;
modifying said ranked employee shifts to provide feasible, ranked employee shifts by conforming said ranked employee shifts to fit within a set of labor and employee constraints; and
compiling said feasible, ranked employee shifts to generate a feasible employee schedule, wherein the feasible employee schedule fully covers the time period.

34. The process of claim 33, wherein said customer traffic data includes numbers of customers walking out of the store detected at regular intervals by an optical sensor or a visual monitoring device.

35. The process of claim 34, wherein the visual monitoring device comprises a mobile chipset with at least one eyestalk sensor coupled to the mobile chipset.

36. The process of claim 35, wherein the mobile chipset supports wireless communication.

37. The process of claim 33, wherein said sales data comprises a list of time-stamped sale transactions and wherein said employee attendance data comprises a list of punch-in and punch-out times for each employee.

38. The process of claim 33, wherein said step of predicting a staff count is achieved by modeling a relationship between a shopper yield and an associate-to-shopper ratio (ATSR) in a way which achieves the highest value for said shopper yield.

39. The process of claim 38, further comprising calculating said shopper-yield by dividing an amount of sales generated over a defined time period by a number of customers leaving the store over the defined time period.

40. The process of claim 38, further comprising calculating the ATSR by dividing the number of employees assigned to work during a defined period by the number of customers leaving the store over the defined period.

41. The process of claim 33, wherein said step of ranking employees comprises:
calculating an attributed shopper yield to each employee based on shifts in which the employee participated and said sales data;
determining, for each employee, a difference between the attributed shopper yield of the employee to a normalized shopper yield; and
ranking employees according to said differences, such that an employee with a higher difference has a higher performance rank than an employee with a lower difference.

42. The process of claim 41, wherein said attributed shopper yield to each employee is calculated based on a number of shifts the employee participated over a predetermined time period and apportioned shopper yields over the time period, each apportioned shopper yield being, for each shift the employee participated, sales of the shift apportioned among employees working on the shift.

43. The process of claim 41, further comprising calculating said normalized shopper yield by dividing an average sales per hour calculated over a defined period of time by an average walkout traffic per hour calculated over said defined period of time.

44. The process of claim 38, wherein said step of matching employees further comprises:
determining an expected shopper yield per shift based on said modeled relationship; and
calculating an estimated sales per shift by multiplying said expected shopper yield per shift for a defined period by an average measure of customer traffic over said defined period.

45. The process of claim 33 wherein the set of labor and employee constraints comprises:
a total time during which the store is open;
a maximum shift length;
a minimum shift length:
a maximum weekly shift length; and
a total labor budget.

46. The process of claim 33, further comprising:
predicting a shopper yield based on said feasible, ranked employee shifts and a normalized shopper yield for each feasible, ranked employee shift;
calculating a difference between said predicted shopper yield and a measured shopper yield; and
reporting an opportunity cost by multiplying the difference to an average walkout traffic for said time period.

47. The process of claim 46, wherein the normalized shopper yield is calculated based on an average sales per hour calculated for the time period and an average walkout traffic per hour calculated over said time period.
